(19) United States
(12) Patent Application Publication
(10) Pub. No.: US 2016/0134958 A1
(43) Pub. Date: May 12, 2016

(54) SOUND TRANSMISSION SYSTEMS AND DEVICES HAVING EARPIECES

(71) Applicant: Microsoft Technology Licensing, LLC, Redmond, WA (US)

(72) Inventors: Nicholas John Vernon Thompson, Mountain View, CA (US); Lorenz Henric Jentz, Seattle, WA (US)

(21) Appl. No.: 14/536,557

(22) Filed: Nov. 7, 2014

(51) Int. Cl. H04R 1/10

(52) U.S. Cl. CPC H04R 1/105

(57) ABSTRACT

Sound transmission systems and devices having non-occluding earpieces are described herein. In one embodiment, an earpiece includes an enclosure configured to be positioned adjacent a user's ear and a transducer disposed in the enclosure. A tube extends from the enclosure toward the ear canal of the user's ear. The tube transmits sound generated by the transducer toward the user's ear without substantially blocking or occluding an entrance to the ear canal.

### CROSS-REFERENCE TO RELATED APPLICATIONS

The present application is related to U.S. patent application Ser. No. ______ (Attorney Docket No. 041827-8024.US00), entitled “EARPIECE ATTACHMENT DEVICES,” filed Nov. 7, 2014, which is incorporated herein by reference in its entirety.

### BACKGROUND

Earpieces are devices that can be worn by a user to listen to sound from an audio signal source (e.g., a mobile device, a personal music player, a computer, a tablet) Some earpieces (i.e., occluding earpieces) can substantially or completely block or occlude an ear on which they are worn. In-ear earbuds, for example, may be designed to be at least partially positioned within the ear canal. Over-ear headphones may be designed to be worn over the entire outer portion of the ear (i.e., the pinna). These so-called occluding earpieces can attenuate sounds coming from around a user, and they may also affect the user's ability to determine the location of sounds in their environment.

### BRIEF DESCRIPTION OF THE DRAWINGS

FIG. 1A is a partially schematic isometric side view of an earpiece attached adjacent a user's ear configured in accordance with an embodiment of the disclosed technology.

FIG. 1B is a schematic diagram of a system configured in accordance with an embodiment of the disclosed technology.

FIG. 1C is a side view of a user's ear.

FIG. 2A is a partially schematic perspective view of an enclosure of an augmented reality device configured in accordance with an embodiment of the disclosed technology. FIG. 2B is a partially schematic side view of the enclosure of FIG. 2A shown disassembled.

FIG. 3 is a perspective view of an elliptical tube configured in accordance with an embodiment of the disclosed technology.

FIG. 4 is a perspective view of a rectangular tube configured in accordance with embodiments of the disclosed technology.

FIG. 5 is a perspective view of a circular tube configured in accordance with embodiments of the disclosed technology.

FIG. 6 is a flow diagram of a process configured in accordance with embodiments of the disclosed technology.

FIGS. 7A and 7B are graphs showing audio signals output by an earpiece configured in accordance with an embodiment of the disclosed technology.

### DETAILED DESCRIPTION

The present disclosure describes various devices, systems and methods of transmitting or delivering audio information to a user. In some embodiments, an earpiece can be configured to be worn proximate a user's ear while substantially allowing the user to hear and localize positions of sounds in his or her environment. In some embodiments, for example, a device (e.g., a sound transmission device, an earpiece) includes an enclosure configured to be positioned adjacent a user's ear spaced apart from an opening to the user's ear. The device also includes a transducer disposed in the enclosure and a tube extending from the enclosure toward the user's ear. The tube is configured, for example, to transmit sound radiated by the transducer from the enclosure toward the user's ear. A distal end portion of the tube is attached to the enclosure near the transducer. A proximal end portion of the tube is configured to be positioned adjacent the user's ear (e.g., in a vestibule leading into the ear canal), but spaced apart from an opening to the ear canal. In some aspects, the distal end portion is configured to be positioned in the cavum conchae of the user's ear without substantially blocking or occluding the opening to the ear canal of the user's ear. In some aspects, the proximal end portion of the tube is rotatably coupled to the enclosure. In some aspects, portions of the tube may have elliptical, circular and/or rectangular cross sections. In some aspects, the tube has a first diameter near the distal end portion and a second diameter, different from the first diameter, near the proximal end portion. For example, the first diameter may be approximately 5-15 mm (e.g., about 10 mm), and the second diameter may be approximately 1-10 mm (e.g., about 5 mm). In some aspects, the transducer is configured to generate acoustic waves at frequencies between about 300 hertz (Hz) and about 10 kilohertz (kHz). In some aspects, the transducer is disposed in a cavity of the enclosure having a volume of approximately two cubic centimeters. In some aspects, the enclosure is configured to be at least partially disposed in a helmet. In some aspects, the enclosure is configured to be positioned adjacent either of the user's ears.

In some embodiments, a system (e.g., a sound transmission system, an augmented or virtual reality system) includes an earpiece. The earpiece includes housing with a transducer assembly disposed therein and a duct extending from the housing. The duct has an inlet in fluid communication with the transducer assembly and an outlet configured to be positioned adjacent a user's ear. The system also includes memory comprising storage modules configured to store instructions and one or more processors coupled to the storage modules and to the transducer assembly. The instructions stored on the storage modules include, for example, instructions for applying a filter to an audio signal. The filter is configured to attenuate at least one of acoustical resonances in the duct. In some aspects, the outlet of the duct is configured to be positioned adjacent a user's ear without substantially blocking or occluding an entrance thereto. In some aspects, portions of the duct have elliptical, circular, and/or rectangular cross sections. In some aspects, the duct is configured to have a first width or diameter near the distal end of the duct and a second, different width or diameter near the proximal end of the duct. In some aspects, the earpiece includes one or more microphones disposed on the housing. In some aspects the instructions stored on the storage modules include, for example, instructions for adjusting a gain of the audio signal based on an ambient sound level measured by the one or more microphones.

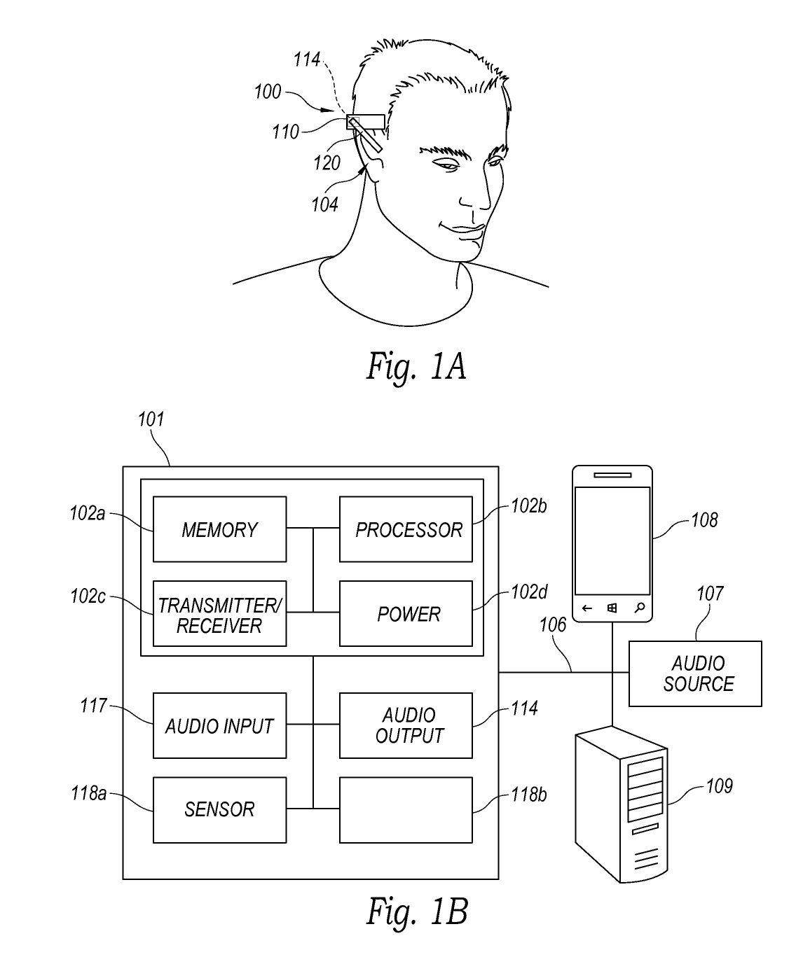

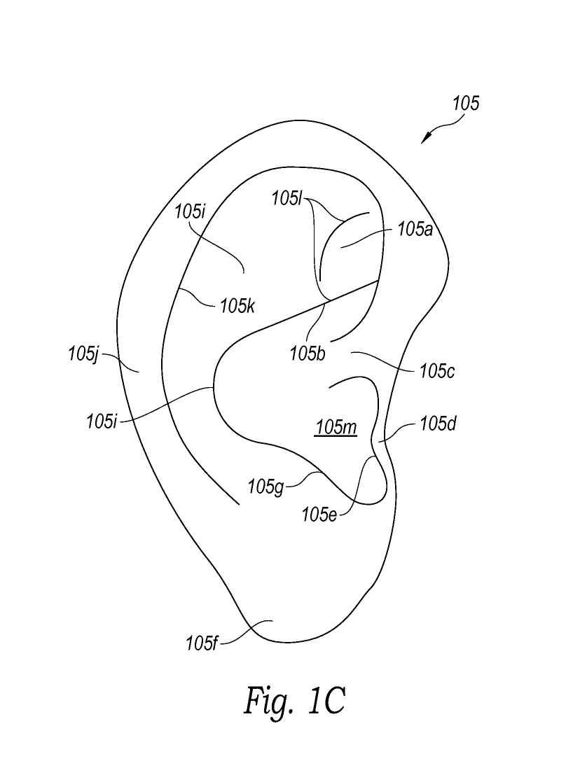

In some embodiments, a method (e.g., a method of transmitting sound from an earpiece, a method of providing augmented reality audio information) includes receiving an audio signal from an audio signal source (e.g., a mobile device, a computer, one or more servers and/or one or more other audio sources). A filter (e.g., a notch filter) is applied to the audio signal that attenuates the audio signal at one or more predetermined frequencies. The filtered audio signal is output to a transducer in fluid communication with a tube that extends from a position proximate the transducer toward a user's ear. In some aspects, the tube includes an inlet positioned at least proximate the transducer. An outlet of the tube is configured to be positioned near the cavum conchae (see, e.g., FIG. 1C) of the user's ear without blocking the opening to the ear canal of the user's ear. In some aspects, the method includes determining one or more resonant frequencies of the tube, and attenuating the audio signal at the one or more resonant frequencies of the tube. In some aspects, the method includes determining an ambient sound pressure level of an environment around and/or near the user and adjusting a gain of the audio signal based on the determined sound pressure level.

These and other aspects of the disclosed technology are described in greater detail below. Certain details are set forth in the following description and in FIGS. 1A-7B to provide a thorough understanding of various embodiments of the disclosed technology. Other details describing well-known structures and systems often associated with earpieces and related methods have not been set forth in the following disclosure to avoid unnecessarily obscuring the description of the various embodiments.

In the Figures, identical reference numbers identify identical, or at least generally similar, elements. To facilitate the discussion of any particular element, the most significant digit or digits of any reference number refers to the Figure in which that element is first introduced. For example, element 110 is first introduced and discussed with reference to FIG. 1. Many of the details, dimensions, angles and other features shown in the Figures are merely illustrative of particular embodiments of the disclosure. Accordingly, other embodiments can have other details, dimensions, angles, and features without departing from the spirit or scope of the present invention. In addition, those of ordinary skill in the art will appreciate that further embodiments of the invention can be practiced without several of the details described below.

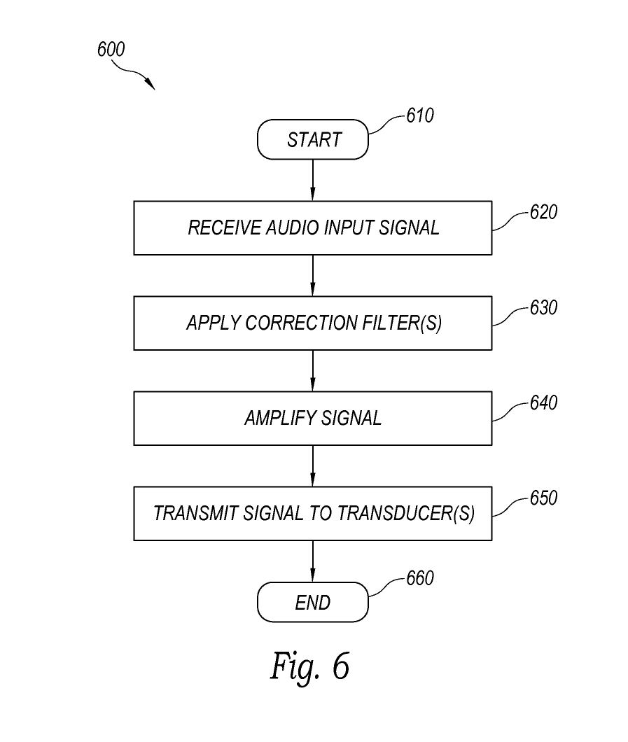

FIG. 1A is an isometric side view of an augmented reality device, a sound transmission device or an earpiece 100 positioned adjacent a user's ear 104 and configured in accordance with an embodiment of the disclosed technology. The earpiece 100 includes a box, a housing, or an enclosure 110 configured to house or carry a transducer assembly 114 (e.g., one or more audio speakers, an array of audio transducers). A tube 120 (e.g., a rectangular duct, a circular duct, an elliptical duct, a waveguide) extends from the enclosure 110 toward the user's ear 104. A distal end portion 121a of the tube 120 is moveably coupled to the enclosure 110 in fluid communication with the transducer assembly 114 housed therein. In other words, at least a portion of the tube 120 defines an airspace, for example, that is coupled to and/or in communication with a portion of the transducer assembly 114. A proximal end portion 121b of the tube 120 is positioned near an entrance of an ear canal of the user's ear 104 (e.g., in a vestibule leading into the ear canal). The proximal end portion 121b is configured to be positioned within or at least proximate the cavum conchae (FIG. 1C) of the user's ear 104 without significantly and/or substantially occluding the ear canal thereof. The tube 120 transmits a substantial amount of the sound generated by the transducer assembly 114 toward the user's ear while allowing the user to perceive or hear a substantial amount of the sounds emanating from his or her environment. In some embodiments, as described in further detail below with reference to FIGS. 1B and 6-7B, the tube 120 can introduce undesirable resonances to sound generated by the transducer assembly 114. The undesirable resonances can be attenuated, for example, by the method described below with reference to FIG. 6.

In the illustrated embodiment of FIG. 1A, the enclosure 110 is shown above the user's ear 104. In some embodiments, the earpiece 100 can be integrated in and/or attached to a device configured to be worn by the user on his or her head. The enclosure 110 can be positioned, for example, within a helmet that can be worn over the user's head and/or in or on a headset that can be worn across an upper portion of the user's head. In some embodiments, the earpiece 100 can be included into an article of clothing (e.g., a hat). Moreover, the illustrated embodiment of FIG. 1A includes a single earpiece having a single tube extending therefrom. In some embodiments, however, one or more additional earpieces can be worn by the user (e.g., one earpiece for each of the user's two ears), each earpiece having one or more tubes extending therefrom.

As described in more detail below with reference to FIGS. 1C-5B, the earpiece 100 can be configured to be worn by the user or otherwise positioned proximate the user's ear 104 such that the tube 120 does not occlude or block an entrance to the ear canal of the user's ear 104. As those of ordinary skill in the art will appreciate, over-ear headphones and/or in-ear earbuds when worn by the user can block the entrance to the ear canal of the user's ear 104, thereby significantly attenuating sounds emanating from the user's environment. In some cases, this may be beneficial, such as, for example, when the user is in the presence of undesirable noise (e.g., on an airplane). Earphones that completely or substantially block the entrance to the ear canal, however, can also reduce the user's ability to localize sounds in the environment. The disclosed technology is expected to provide a benefit of transmitting audio information via the earpiece 100 to the user while also allowing the user to hear a substantial portion of the sounds from his or her environment. The disclosed technology may provide another benefit of transmitting a greater portion of the lower frequency content (e.g., frequencies less than about 300 Hz) generated by the transducer assembly 114 than earpieces without the tube 120. The disclosed technology may also provide a benefit of allowing the use of a smaller and/or more efficient transducer, thereby providing cost benefits and/or decreased power consumption compared to transducers used with conventional non-occluding earpieces.

FIG. 1B and the following discussion provide a brief, general description of a suitable environment in which the technology may be implemented. Although not required, aspects of the technology are described in the general context of computer-executable instructions, such as routines executed by a general-purpose computer. Aspects of the technology can be embodied in a special purpose computer or data processor that is specifically programmed, configured, or constructed to perform one or more of the computer-executable instructions explained in detail herein. Aspects of the technology can also be practiced in distributed computing environments where tasks or modules are performed by remote processing devices, which are linked through a communication network (e.g., a wireless communication network, a wired communication network, a cellular communication network, the Internet, a hospital information network). In a distributed computing environment, program modules may be located in both local and remote memory storage devices.

Computer-implemented instructions, data structures, screen displays, and other data under aspects of the technology may be stored or distributed on computer-readable storage media, including magnetically or optically readable computer disks, as microcode on semiconductor memory, nanotechnology memory, organic or optical memory, or other portable and/or non-transitory data storage media. In some embodiments, aspects of the technology may be distributed over the Internet or over other networks (e.g. a Bluetooth network) on a propagated signal on a propagation medium (e.g., an electromagnetic wave(s), a sound wave) over a period of time, or may be provided on any analog or digital network (packet switched, circuit switched, or other scheme).

FIG. 1B is a schematic diagram of a system 101 configured in accordance with an embodiment of the disclosed technology. A communication link 106 [e.g., a wired communication link and/or a wireless communication link (e.g., Bluetooth, WiFi, infrared and/or another wireless radio transmission network)] communicatively couples the system 101 to one or more audio sources 107 (e.g., systems, devices and/or components that generate audio information), a mobile device 108 (e.g., a cellular phone, a smartphone, tablet, a personal digital assistant (PDA), a laptop and/or another suitable portable electronic device) and/or one or more computers 109 (e.g., a local computer, a remote computer, one or more remote servers). As explained in more detail below, the system 101 can be implemented, for example, with one or more earpieces (e.g., the earpiece 100 of FIG. 1A), and may be configured, for example, to provide an augmented reality experience to a user.

The system 101 includes system electronics 102 coupled to the transducer assembly 114, one or more audio inputs 117 (e.g., one or more microphones), one or more sensors 118a (e.g., one or more accelerometers, thermometers, hygrometers, blood pressure sensors, altimeters, gyroscopes, magnetometers, proximity sensors, barometers, hall effect sensors), and one or more optional components 118b (e.g., one or more digital signal processors, GPS receivers). In some embodiments, the system 101 can comprise a single System on Chip within the earpiece 100 and/or another suitable audio playback device. In certain embodiments, for example, the system electronics 102 is implemented as a component in an earpiece separate from the transducer assembly 114, the one or more audio inputs 117, the one or more sensors 118a and/or the one or more optional components 118b. Moreover, in some embodiments, the transducer assembly 114 can include a transducer configured to radiate in a wideband range of frequencies (e.g., between about 20 Hertz (Hz) and about 20 kilohertz (kHz), between about 100 Hz and about 15 kHz, and/or between about 300 Hz and about 10 kHz). In some embodiments the transducer assembly 114 can comprise any suitable audio transducer (e.g., an electroacoustic loudspeaker, a piezoelectric transducer, an electrostatic transducer).

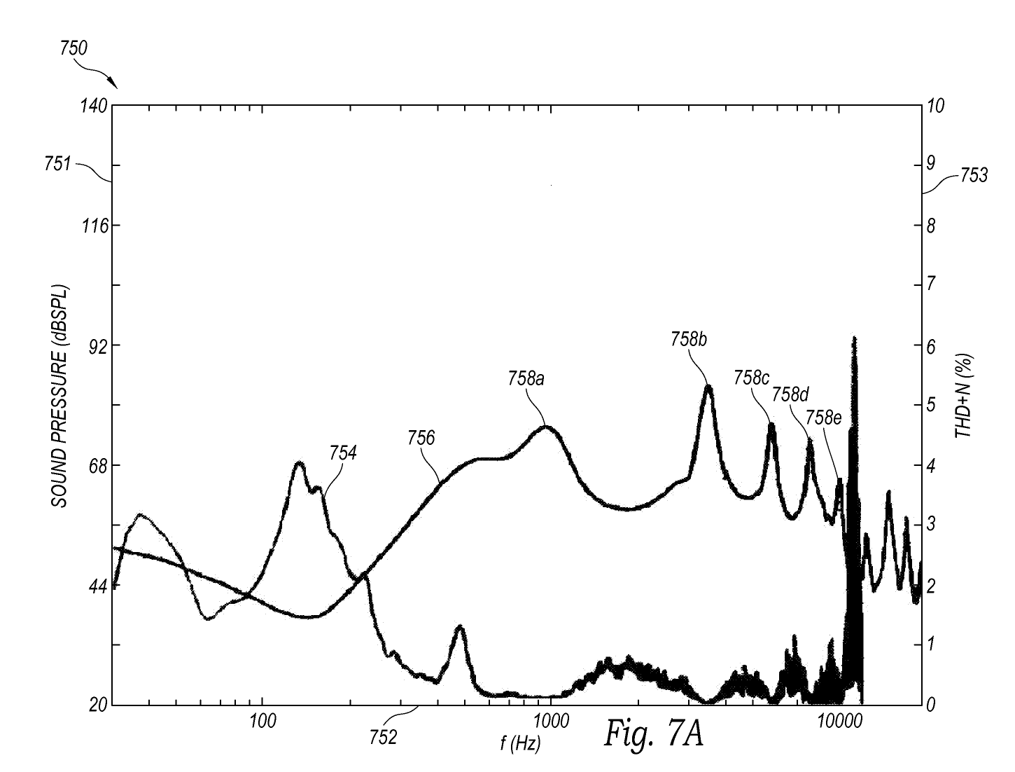

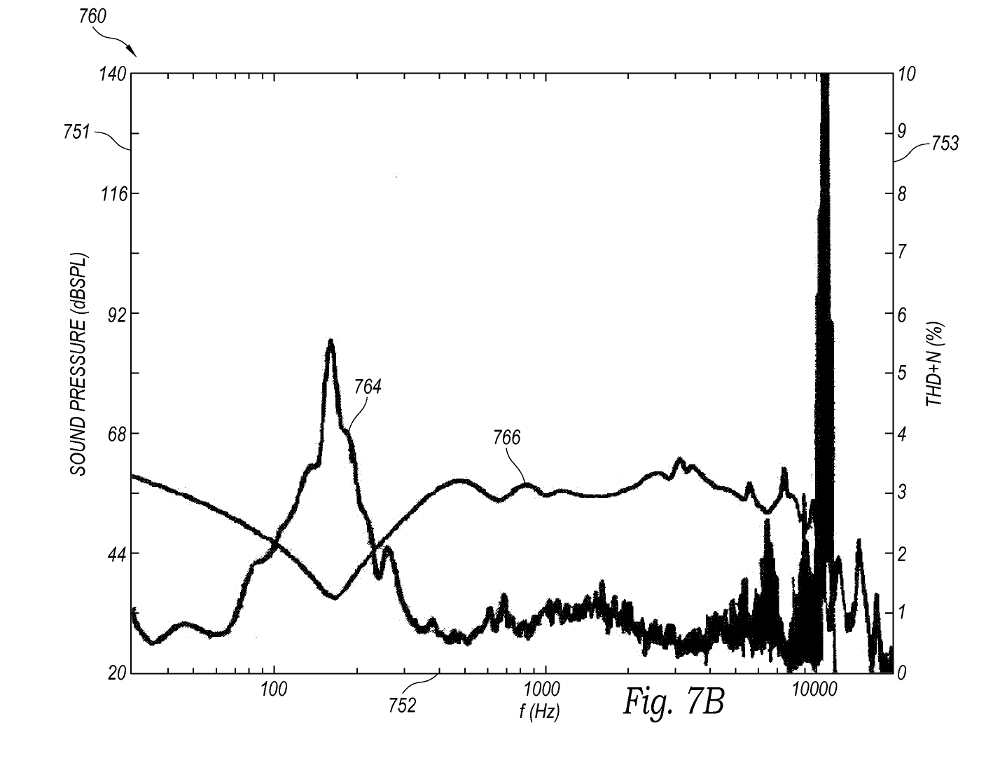

The system electronics 102 includes several components including memory 102a (e.g., one or more computer readable storage modules, components, devices), one or more processors 102b, transmit and receive components 102c (e.g., an antenna) and a power supply 102d (e.g., one or more batteries). In some embodiments, the system electronics 102 may include additional components not shown in FIG. 1B. The memory 102a can be configured to store information (e.g., user information or profiles, environmental data, data collected from one or more sensors, media files) and/or executable instructions that can be executed by one or more processors 102b. As explained in further detail below with reference to FIGS. 6-7B, the memory 102a can include, for example, instructions for enhancing audio signals to be output from the transducer assembly 114 to the user via a duct or tube (e.g., the tube 120 of FIG. 1A). The transmit and receive components 102c can be configured to transmit data (e.g., voice input data from the user) to the one or more audio sources 107, the mobile device 108, the one or more computers 109 and/or another external device. The transmit and receive components 102c can also be configured to receive data (e.g., data containing audio information for playback via the transducer assembly 114) from the one or more audio sources 107, the mobile device 108, the one or more computers 109 and/or another external device. The power supply 102d can provide electrical power to components of the system 101 and/or the system electronics 102. The power supply 102d can comprises one or more batteries and can be rechargeable via a power cable, inductive charging and/or another suitable recharging method.

In the illustrated embodiment, the system electronics 102 is implemented with the components 102a-d described above. In some embodiments, the system electronics 102 can be implemented, for example, on a single System on Chip (SoC). In come embodiments, one or more of the components comprising the system electronics may be distributed across several locations and/or platforms. In certain embodiments, for example, the transmitter/receiver component 102c and the power supply 102d may be disposed in and/or on an earpiece (e.g., the earpiece 100 of FIG. 1A) configured to be worn by a user, while the memory 102a and the processors 102b may be disposed on a mobile device (e.g., the mobile device 108) or a computer (e.g., the one or more computers 109) remote from the earpiece.

FIG. 1C is a side view of a pinna 105 of a user's ear. Anatomic structures and features common found on the pinna of human ears are shown in FIG. 1C for the reader's reference. The pinna 105 includes a fossa triangularis 105a, a cymba conchae 105b, a crux of the helix 105c, a tragus 105d, an ear canal 105e, an ear lobe 105f, an antitragus 105g, an antihelix 105i, a helix 105j, a scaphoid fossa 105k, a crura of an antihelix 105l and a cavum conchae 105m (e.g., an auricular cavity). Additional anatomical structures are not shown for clarity.

Non-occluding earpieces can include, for example, earpieces worn by a user that do not completely or at least substantially occlude or block an entrance to the ear canal 105e of the pinna 105. Embodiments of the present technology may include earpieces (e.g., the earpiece 100 of FIG. 1A) having tubes (e.g., the tube 120 of FIG. 1A) that extend toward the ear canal 105e, but do not block an entrance thereto. In some embodiments, the tubes (e.g., the tube 120 of FIG. 1A) may have end portions that extend at least partially into the cavum conchae 105m. As those of ordinary skill in the art will also appreciate, the cavum conchae 105m can comprise a space at least partially defined by the antihelix 105i that forms a vestibule leading into the ear canal 105e. An earpiece (e.g., the earpiece 100 of FIG. 1A) having a tube that extends into the cavum conchae 105m without substantially blocking the ear canal 105e can provide a directed sound path into the user's ear (e.g., via waves generated by a transducer in fluid communication with the tube) while also allowing the user to perceive sounds from his or her environment.

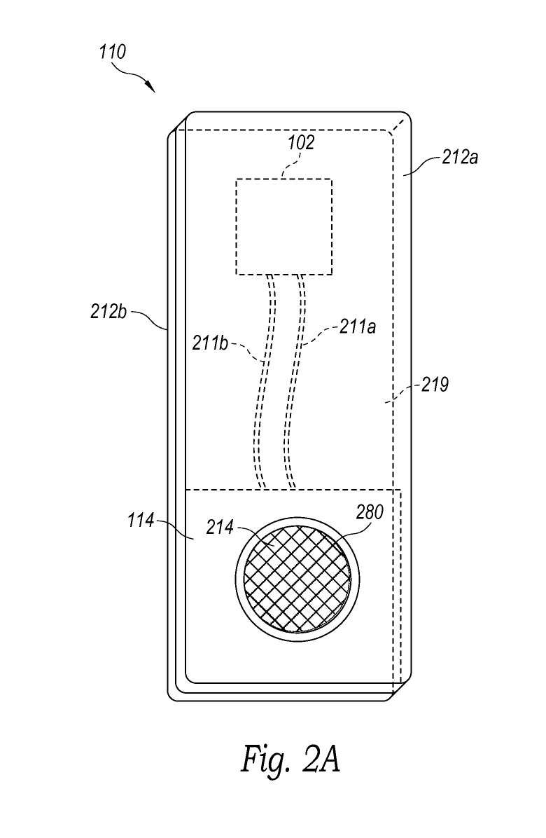

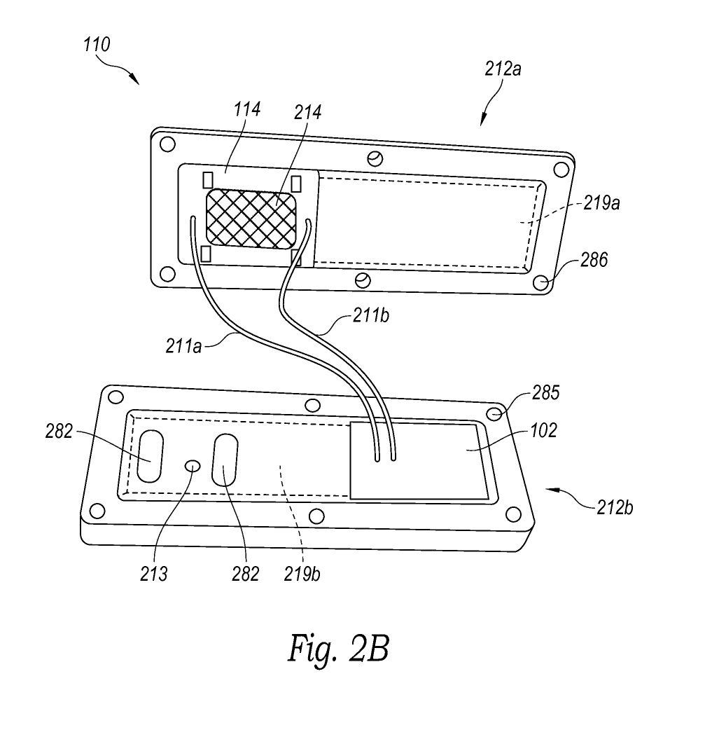

FIG. 2A is a partially schematic perspective view of the enclosure 110 of earpiece 100 shown in an assembled state. FIG. 2B is a partially schematic side view of the enclosure 110 shown disassembled. Referring to FIGS. 2A and 2B together, the enclosure 110 comprises a first side portion 212a and a second side portion 212b. The first and second side portions 212a and 212b include interior surfaces having corresponding recesses 219a and 219b formed therein. The transducer assembly 114 is at least partially disposed within the recess 219a and is spaced apart from the second recess 219b by a pair of transducer support structures 282 (e.g., pads) extending therefrom. When the enclosure 110 is in the assembled state (FIG. 2A), the first and second recesses 219a and 219b form a cavity 219 within the enclosure 110. The cavity 219 can have a volume between about 0.5 cm³ and about 5 cm³ (e.g., approximately 2 cm³). Positioning at least a portion of the transducer assembly 114 in the cavity 219 may enhance acoustic radiation of certain frequencies (e.g., less than about 1 kilohertz) from the transducer assembly 114.

A plurality of wires 211 (identified separately as a first wire 211a and a second wire 211b) electrically couple the transducer assembly 114 to the system electronics 102 disposed in the enclosure 110. An aperture 213 (FIG. 2B) in the second portion 212b can allow one or more additional wires to pass therethrough. In the illustrated embodiment, a plurality of holes 285 in the second portion 212b receive corresponding posts 286 extending from the first portion 212a to join the first and second portions 212a and 212b together. In some embodiments, any suitable attachment device, structure, or material (e.g., screws, an adhesive, snaps) can be used to attach the first portion 212a to the second portion 212b.

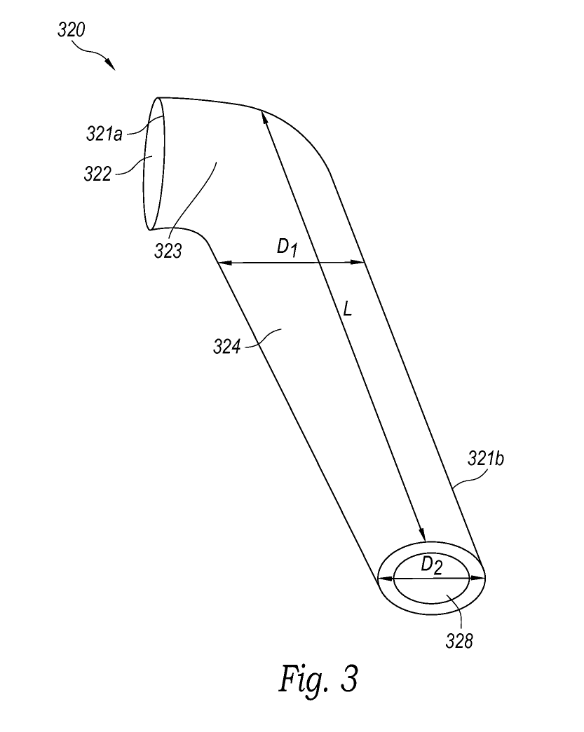

As explained above with reference to FIG. 1B, the system electronics 102 can receive audio information from an external source (e.g., the mobile device 108 of FIG. 1B), and transmit the audio information via electrical signals through the wires 211 to the transducer assembly 114. A transducer surface 214 (e.g., a speaker cone) oscillates within the transducer assembly 114 in response to the electrical signals. In some embodiments, as explained in further detail below with reference to FIGS. 3-5, a tube extending from the enclosure 110 toward the user's ear canal 105e (FIG. 1C) can transmit sound radiated from the transducer assembly 114 to the user's ear without substantially blocking or occluding an entrance to the ear canal 105e. Moreover, in some embodiments, the enclosure 110 is configured to be positioned adjacent a user's ear as shown, for example, in FIG. 1A. In some embodiments, the enclosure 110 can be integrated within or otherwise positioned in and/or on a device (e.g., a helmet, a headband) configured to be worn on the user's head. In some embodiments, the enclosure 110 can be attached directly to the user's ear using, for example, a clip and/or another attachment device.

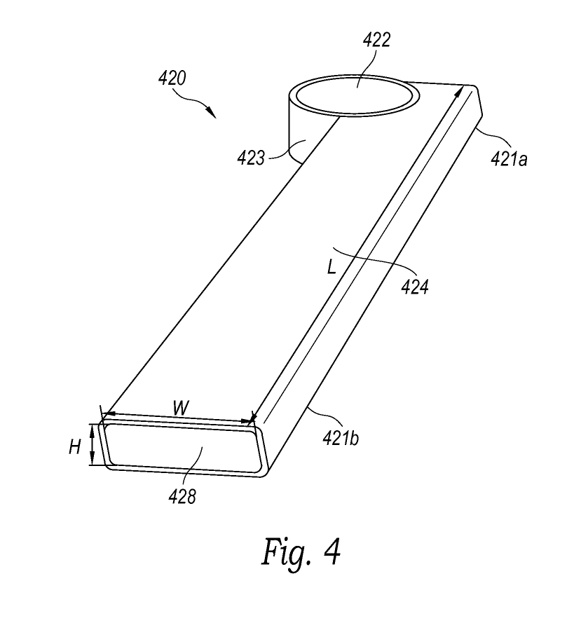

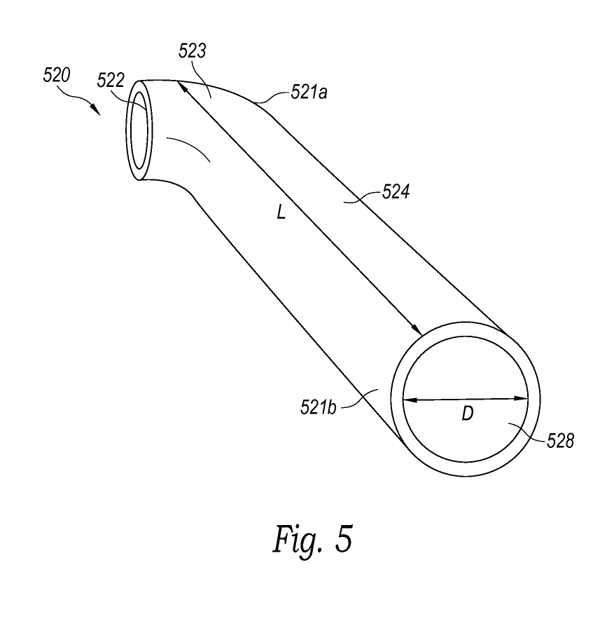

FIG. 3 is a perspective view of an elliptical duct or a tube 320. FIG. 4 is a perspective view of a rectangular duct or tube 420. FIG. 5 is a perspective view of a circular duct or tube 520. Referring to FIGS. 3-5 together, the tubes 320, 420, and 520 are configured to be moveably attachable (e.g., rotatably coupled) to the enclosure 110 to allow the user to wear the earpiece 100 interchangeably on either a left ear or a right ear. When attached to the enclosure 110, the tubes 320, 420 and 520 can extend therefrom toward to a user's ear (similar to the tube 120 shown in FIG. 1A) and transmit sound generated by the transducer assembly 114 (FIGS. 2A and 2B) toward the user's ear. The tubes 320, 420 and 520 can be made of, for example, plastic (e.g., polyethylene, polyvinyl chloride, polycarbonate), metal (e.g., aluminum), glass and/or another suitable material. In some embodiments, for example, the tubes 320, 420 and 520 may be configured to be telescoping and may be capable of being retracted or otherwise lengthened or shortened.

Referring again to FIG. 3, the tube 320 extends between a distal end portion 321a and a proximal end portion 321b. An inlet 322 at the distal end portion 321a is configured to be positioned proximate the outlet 280 of the enclosure 110 in fluid communication with the transducer assembly 114 (FIG. 2A). An outlet 328 at the proximal end portion 321b is configured to be positioned at least proximate in the cavum conchae 105m (FIG. 1C) of the user's pinna 105 without significantly occluding or blocking an entrance to the ear canal 105e. An intermediate portion 324 of the tube 320 extends between an elbow 323 proximate the inlet 322 toward the outlet 328. The intermediate portion 324 has a length L (e.g., between about 30 mm and about 120 mm, between about 45 mm and about 90 mm, or about 65 mm) and tapers from a first diameter D1 (e.g., between about 5 mm and about 15 mm, or about 10 mm) to a second diameter D2 (e.g., between about 1 mm and 10 mm, or about 5 mm).

Referring next to FIG. 4, the tube 420 extends between a distal end portion 421a and a proximal end portion 421b. An inlet 422 at the distal end portion 421a is configured to be positioned proximate the outlet 280 of the enclosure 110 in fluid communication with the transducer assembly 114 (FIG. 2A). An outlet 428 at the proximal end portion 421b is configured to be positioned at least proximate in the cavum conchae 105m (FIG. 1C) of the user's pinna 105 without occluding or blocking an entrance to the ear canal 105e. An intermediate portion 424 of the tube 420 extends between an elbow portion 423 proximate the inlet 422 toward the outlet 428. The intermediate portion 424 has a length L (e.g., between about 30 mm and about 120 mm, between about 45 mm and about 90 mm or about 65 mm), a width W (e.g., between about 5 mm and about 15 mm, or about 9 mm), and a height H (e.g., between about 0.5 mm and 10 mm, or about 2 mm).

Referring next to FIG. 5, the tube 520 extends between a distal end portion 521a and a proximal end portion 521b. An inlet 522 at the distal end portion 521a is configured to be positioned proximate the outlet 280 of the enclosure 110 in fluid communication with the transducer 115 (FIG. 2A). An outlet 528 at the proximal end portion 521b is configured to be positioned at least proximate in the cavum conchae 105m (FIG. 1C) of the user's pinna 105 without occluding or blocking an entrance to the ear canal 105e. An intermediate portion 524 of the tube 520 extends between an elbow portion 523 proximate the inlet 522 toward the outlet 528. The intermediate portion 524 has a length L (e.g., between about 30 mm and about 120 mm, between about 45 mm and about 90 mm or about 65 mm) and a diameter D (e.g., between about 5 mm and about 15 mm, or about 10 mm). In the illustrated embodiment of FIG. 5, the tube 520 has a substantially constant diameter D. In some embodiments, the diameter of the tube 520 can taper from a first diameter proximate the elbow portion 523 to a second, different diameter proximate the outlet 528.

FIG. 6 is a flow diagram of a process 600 of processing audio signals, and configured in accordance with an embodiment of the present technology. In some embodiments, the process 600 can comprise instructions stored, for example, on the memory 102a of the system 101 (FIG. 1B) that are executable by the one or more processors 102b. In some embodiments, portions of the process 600 may be performed by one or more hardware components (e.g., a digital signal processor included with one or more of the optional components 118b of FIG. 1B). In some embodiments, portions of the process 600 may be performed by a device external to the system 101 (e.g., the one or more audio sources 107, the mobile device 108 and/or the one or more computers 109 of FIG. 1B).

The process 600 begins at block 610. At block 620, the process 600 receives one or more audio signals from an external audio source (e.g., the one or more audio sources 107, the mobile device 108 and/or the one or more computers 109 of FIG. 1B).

At block 630, the process 600 applies one or more correction filters to the audio signal. As those of ordinary skill in the art will appreciate, a transducer (e.g., the transducer assembly 114) positioned at one end of a tube (e.g., the tubes 320, 420 and/or 520) may generate sound that is degraded or otherwise distorted by resonances in the tube as the sound propagates through the tube. As those of ordinary skill in the art will appreciate, a tube can have resonances at one or more frequencies based on, for example, one or more characteristics of the tube (e.g., boundary conditions of the tube, dimensions of the tube, an acoustic impedance of the tube, construction of the tube, a medium traveling through the tube).

The process 600 can calculate or otherwise determine (e.g., via accessing a lookup table stored on the memory 102a of FIG. 1B) one or more of the resonant frequencies of the tube, and applying one or more filters at the calculated and/or predetermined frequencies. Applying the one or more filters can include, for example, applying a notch filter configured to attenuate the audio signal at one or more of the resonant frequencies of the tube. Attenuating the audio signal at the resonance frequencies of the tube can provide a benefit of the enhanced perception by the user of sound emitted from transducer (e.g., increased speech clarity of audio having voice content, reduced harshness or distortion of audio having music content). In some embodiments, the process 600 at block 630 can apply additional filters to the audio signal such as, for example, a bandpass filter (e.g., a low pass filter, a high pass filter), a head related transfer function (HRTF), and/or another suitable audio signal filter. In some embodiments, the process 600 at block 630 can use filters obtained, for example, using one or more techniques described by Dana C. Massie in “An Engineering Study of the Four-Multiply Normalized Ladder Filter,” published July 1993 in the Journal of the Audio Engineering Society, Volume 41 Issue 7/8 pp. 564-582, and incorporated by reference herein in its entirety.

At block 640, the process 600 amplifies the filter corrected signal from block 630. The process 600 can determine, for example, an average sound pressure level (e.g., an a-weighted sound pressure level, a c-weighted sound pressure level) of the user's environment (e.g., using measurements from one or more microphones, such as the audio inputs 117 of FIG. 1B). Based on the determined sound pressure level, the process 600 can correspondingly adjust (e.g., increase or decrease) a gain of the filter-corrected signal. In some embodiments, the process 600 may be configured, for example, to output a gain-adjusted audio signal that the user will perceive as having substantially the same intensity (e.g., volume) as the ambient noise in the user's environment.

At block 650, the filtered and gain-adjusted signal is transmitted to a transducer (e.g., via the system electronics 102 to the transducer assembly 114 of FIG. 1B). At block 660, the process 600 ends.

FIGS. 7A and 7B are graphs 750 and 760, respectively of an acoustic signal produced by the earpiece 100 (e.g., emitted from the transducer assembly 114) and measured, for example, near an outlet of a tube (e.g., near outlet 328 of the tube 320 of FIG. 3). The graph 750 shows the measured acoustic signal without a tube correction filter applied, and the graph 760 shows the measured acoustic signal with a tube correction filter applied (e.g., by the process 600 of FIG. 6). Referring to FIGS. 7A and 7B together, the graphs 750 and 760 include a first axis 751 corresponding to a sound pressure level measured in decibels (dB), a second axis 752 corresponding to frequency measured in Hertz (Hz) and a third axis corresponding to a percentage of total harmonic distortion plus noise (THD+N). Referring again to FIG. 7A, the graph 750 includes a first response 754 indicative of THD+N of the measured acoustic signal, and a second response 756 indicative of a sound pressure level of the measured acoustic signal. The second response includes peaks 758a-e corresponding, for example, to resonances in the signal caused by the tube. Referring next to FIG. 7B, the graph 760 includes a first filtered response 764 indicative of THD+N of the measured acoustic signal, and a second filtered response 766 indicative of a sound pressure level of the measured acoustic signal. The response 766 does not include resonant peaks (e.g., the peaks 758a-e of FIG. 7A) and is a much flatter response than the second response 756 of FIG. 7A. As those of ordinary skill in the art will appreciate, a signal with a relatively flat frequency response is likely to be perceived by a listener as corresponding to a higher quality signal than a signal with one or more resonant peaks (e.g., the second response 756 of FIG. 7A).

From the foregoing, it will be appreciated that specific embodiments of the invention have been described herein for purposes of illustration, but that various modifications may be made without deviating from the spirit and scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

1. A device, comprising:
an enclosure;
a transducer disposed in the enclosure; and
a tube extending from the enclosure, wherein the tube includes a distal end portion and a proximal end portion, wherein the distal end portion is attached to the enclosure, wherein the distal end portion is in substantial fluid communication with the transducer, and wherein the proximal end portion is configured to be positioned adjacent a user's ear, but spaced apart from an opening to the ear canal of the user's ear.

2. The device of claim 1 wherein the distal end portion is configured to be positioned in the cavum conchae of the user's ear without occluding the opening to the ear canal of the user's ear.

3. The device of claim 1 wherein the proximal end portion of the tube is rotatably coupled to the enclosure.

4. The device of claim 1 wherein at least a portion of the tube has an elliptical cross section.

5. The device of claim 1 wherein at least a portion of the tube has a circular cross section.

6. The device of claim 1 wherein at least a portion of the tube has a rectangular cross section.

7. The device of claim 1 wherein the tube has a first diameter near the distal end portion and a second diameter, different from the first diameter, near the proximal end portion.

8. The device of claim 1 wherein the enclosure is configured to be at least partially disposed in a helmet.

9. The device of claim 1 wherein the user's ear is a first ear, wherein the user has a second ear, and wherein the enclosure is configured to be interchangeably positioned adjacent the first ear or the second ear.

10. The device of claim 1 wherein the enclosure includes a cavity having a volume of approximately two cubic centimeters, and wherein at least a portion of the transducer is disposed in the cavity.

11. A system, comprising:
an earpiece having a housing, a transducer assembly disposed in the housing, and a duct extending from the housing, wherein the duct has an inlet in fluid communication with the transducer assembly and an outlet configured to be positioned adjacent a user's ear;
memory comprising storage modules configured to store instructions; and
one or more processors coupled to the storage modules and to the transducer assembly, wherein the instructions stored on the storage modules include instructions for applying a filter to an audio signal, and wherein the filter is configured to attenuate at least one of acoustical resonances in the duct.

12. The system of claim 11 wherein the outlet of the duct is configured to be positioned adjacent a user's ear without substantially blocking an entrance thereto.

13. The system of claim 12 wherein the duct has an elliptical cross section.

14. The system of claim 12 wherein the duct has a first width near the distal end and a second, different width near the proximal end.

15. The system of claim 12, wherein the earpiece further comprises a microphone disposed on the housing, and wherein the instructions stored on the storage modules further include instructions for adjusting a gain of the audio signal based on an ambient sound level measured by the microphone.

16. A method comprising:
receiving an audio signal from an audio signal source;
applying a filter to the audio signal, wherein applying the filter comprises attenuating the audio signal at one or more predetermined frequencies; and
outputting the filtered audio signal to a transducer in fluid communication with a tube, wherein the tube extends from a first position proximate the transducer toward a second position proximate user's ear.

17. The method of claim 16, further comprising determining one or more resonant frequencies of the tube, wherein applying the filter to the audio signal comprises attenuating the audio signal at the one or more resonant frequencies of the tube.

18. The method of claim 16, further comprising:
determining an ambient sound pressure level of an environment of the user; and
adjusting a gain of the audio signal based on the determined sound pressure level.

19. The method of claim 16 wherein applying the filter comprises applying a notch filter to the audio signal at the one or more predetermined frequencies.

20. The method of claim 16 wherein the tube extends between an inlet and an outlet, wherein the inlet is positioned proximate the transducer, and wherein the outlet is positionable adjacent the cavum conchae of the user's ear without blocking the opening to the ear canal of the user's ear.
